(19) United States
(12) Patent Application Publication
(10) Pub. No.: US 2007/0115118 A1
(43) Pub. Date: May 24, 2007

(54) Multiple safety monitoring system

(76) Inventors: Ho-Chuan Hsu, Kaohsiung Hsien (TW); Ching-Wen Huang, Taipei Hsien (TW)

Correspondence Address: HSU, HO-CHUAN, 235 Chung-Ho, Box 8-24, Taipei, TW

(21) Appl. No.: 11/281,757

(22) Filed: Nov. 18, 2005

(51) Int. Cl. G08B 13/00; B60R 25/00; G08B 19/00

(52) U.S. Cl. 340/541; 340/522; 340/5.7

(57) ABSTRACT

A multiple safety monitoring system comprises a weight meter in a first control section; a door of a control section having a card reader for identifying a card for determining a person; the weight meter serving for measuring a weight of a person; the value of measured weight being transferred and stored in a central control system of a computer through a protocol converter and a hub for contrasting and determining whether the weight is within a permissible range; in the first control section, each time, only a person is permitted to enter into the door of the first control section; monitors arranged in the second and third control section for determining movement of persons in the control sections; the monitors having monitor recording systems which are connected to a programmable logic device electrically; and signals being transferred to the programmable logic device for processing.

### FIELD OF THE INVENTION

The present invention relates to safety systems, and in particular to a multiple safety monitoring system, wherein a weight meter is installed at a door of a first control section. Monitors are installed at the second and third control sections for detecting the movement of the persons in the control sections so that the system can determine whether more persons than permissible enter into the control sections.

### BACKGROUND OF THE INVENTION

Entries of buildings, such as plants, laboratories, etc., are installed with monitors or entry control systems for monitoring the environments. However in the prior art, the appearances of entering peoples or keys are used to determine whether a person is permissible to enter into the system. However it is possible that once the door is opened, many people enter into the door once. Thereby other peoples come with the permitted person are not recorded. Thus the function of safety is lost.

### SUMMARY OF THE INVENTION

Accordingly, the primary object of the present invention is to provide a multiple safety monitoring system, wherein a weight meter is installed at a door of a first control section. Monitors are installed at the second and third control sections for detecting the movement of the person in the control sections so that the system can determine whether more persons than permissible enter into the control sections.

To achieve above objects, the present invention provides a multiple safety monitoring system which comprises a weight meter in a first control section; a door of a control section having a card reader for identifying a card for determining a person; the weight meter serving for measuring a weight of a person; the value of measured weight being transferred and stored in a central control system of a computer through a protocol converter and a hub for contrasting and determining whether the weight is within a permissible range; in the first control section, each time, only a person is permitted to enter into the door of the first control section; monitors arranged in the second and third control section for determining movement of persons in the control sections; the monitors having monitor recording systems which are connected to a programmable logic device electrically; signals being transferred to the programmable logic device for processing; the programmable logic device determining whether the entering persons are greater than two and determining whether it is necessary to trigger an alarm; and the programmable logic device serving to control the states in the second and third control sections.

### BRIEF DESCRIPTION OF THE DRAWINGS

FIG. 1 is a block diagram of the multiple safety monitoring system of the present invention.

FIG. 2 shows one embodiment of the multiple safety monitoring system of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

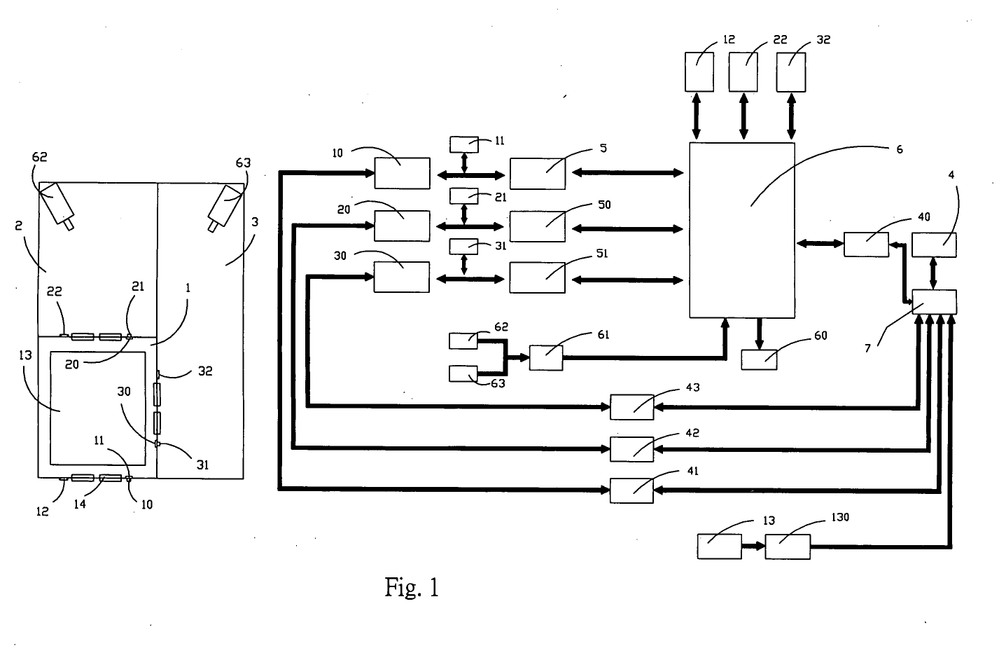

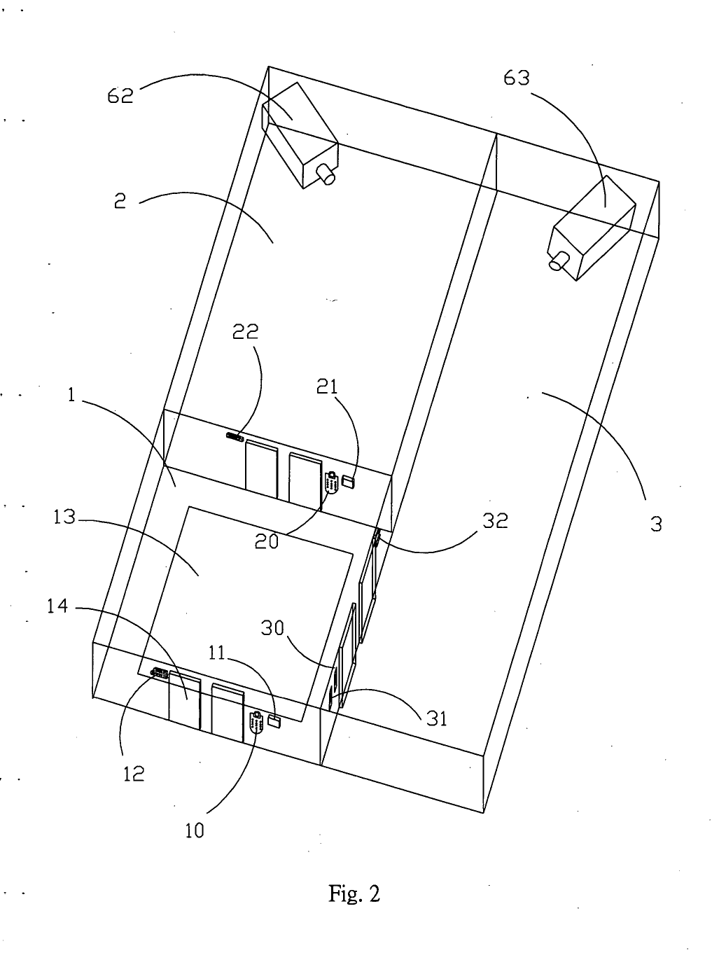

A multiple safety protection and monitoring system (referring to FIGS. 1 and 2) includes a weight meter 13 which is arranged at a first control section 1. The weight meter 13 is connected to a central control system 4 through a hub 7 and a protocol converter 130.

A plurality of card readers at a door of the first control section 1 and the second control section 2 and third control section 3 are connected to the headers 11, 21, and 31. The card readers 10, 20 and 30 are connected to the power modules 5, 50 and 51 electrically so as to be further connected to a programmable logic device 6. The data is recorded to a central control system 4 of a computer through the protocol converter 40. The programmable logic device 6 performs internal logic control to lock or unlock the electronic locks 12, 22 and 32. The card reader 10 at the door 14 serves to identify the cards. The card reader 10 transfers data to the programmable logic device 6 through a power module 5 so as to control the lock and unlock of the electronic lock 12. The weight meter 13 of the first control section 1 serves to measure the weight. The data is transferred to the protocol converter 130 and the hub 7 so as to be recorded in the central control system. Each time only one people is permissible to pass through the first control section 1. The weight of the person is measured to determine whether he (or she) is permitted to enter into any control section. When the card number of the person is authorized to enter into any control section. The card number is further determined whether it is authorized at the card readers 20 and 30 of the first and second control sections. The weight measured from the weight meter 13 is used to opening the electronic locks 22, 32 in the range set by the central control system 4 so as to enter into the third and fourth control sections 3, 4. The second and third control sections 2, 3 are arranged with monitors 62, 63 for assisting the monitor recording system 6.

The card is checked in the door 14 and then is authorized to open the door 14. The person can measure the weight in the weight meter 13. If the person is permissible in the card reader 20 of the first control section 1, the electronic lock 22 is unlocked to open the door of the second control section 2. Then weight can be used to actuate the electronic lock 32 to open the door of the third control section 3 to enter into the third control section 3. Namely, all the control sections and paths have different monitor systems. In the second control section, the detection image and number of persons recorded is used to determine whether it is necessary to actuate an alarm. The detail will be described herein.

A Normal Detection State:

2-1. The card reader 10 at the door 14 reads the numbers of cards to determine whether it is permissible.

2-2. The person is authorized to enter into the door 14, the first and second control sections 1, 2. The signals are transferred to the power modules 5, 50 and 51. The related relay is driven according to the received signals. Finally, the signals are transferred to the programmable logic device 6 for driving the electronic locks 12, 22, 32 to open doors. At the same time, the central control system 4 searches the setting weight of the person according to the number of the card. When the person enters into the door 14, the weight meter 13 will measure the weight. The weight is contrasted in the central control system 4, if it is in a predetermined range, the result is transferred to the programmable logic device 6. If the weight is matched, when the card is read in the card readers 10, 20 and 30, the programmable logic device 6 will actuate the electronic locks 12, 22, 32 to open respective doors (also the person must be authorized in the card readers 10, 20 30).

The condition that he card reader 10 at the door 14 determines whether a card is permissible.

3-1 It must that the card number is authorized in the card reader 20 of the door 14.

3-2 The conditions for opening the door is that card number is authorized in the card readers 10, 20 and 30 and the weight of the person is in a set range. If both matched, the person is permissible to enter the door.

3-3 The central control system 4 polls all the card readers 10, 20 30 for downloading data to the central control system 4 for processing and storage. If no new data, the poll is performed continuously.

3-3-1. The processing way is to analyze the record, to identify the data source and counts number of persons, to transfer data to the programmable logic device 6 for controlling usage.

Monitor After Entering Into Control Sections:

4-1. The card readers 10, 20, 30 retain data about persons passed through. The data is operated, analyzed by system software so as to know the number of persons passed through.

4-2 In the second and third control sections, images are captured. If person moves, the images are transferred to the programmable logic device 6 through a monitor image system 61 to inform the movement of that person.

4-3 The programmable logic device 6 determines to trigger an alarm 60 according to the number of entering person at the last card reader and he movement of the person in the control section detected by the monitor recording system 61 and the recorded card number and weight (the number of entering person is recorded in the programmable logic device 6 and the weight is recorded in the control section 4).

The conditions for normal operation.

5-1 The programmable logic device 6 determines whether the number of entering person is greater than or equal to two and the monitor recording system 60 returns that the signal being one (representing movement of persons).

5-2 When the number of entering person is now greater than 1, and at least one person enters into the control section in a predetermined time period, the number of person in the control section is greater than or equal to two (if over the setting time, no person enters into the control section, the alarm 60 is triggered).

About 5-1, 5-2, and 5-3 are suitable for the minimum number of entering person.

5-1 States other than those described in FIGS. 5-1, 5-2 will cause the programmable logic device 6 to trigger the alarm 60.

5-3 The number of doors may be grater than one. In all states, the central control system 4 polls the card readers of all doors for collecting the data and weight from the card readers. Theses data are analyzed and then are transferred to the programmable logic device 6. The programmable logic device 6 receives these data and data from the monitor recording system 61 to make related responses.

5-4 The condition for leaving the door is determined by the card number and the weight of that person to leave from the door. If the two states are matched, the door will open (if no weight data exists, the card number is singly used as a base for determination.)

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A multiple safety monitoring system comprising:
a weight meter installed in a first control section; a door of a first control section having a card reader for identifying a card for determining whether a person is permissible to enter into the door; the weight meter serving for measuring a weight of a person; the value of measured weight being transferred and stored in a central control system of a computer through a protocol converter and a hub for contrasting and determining whether the weight is within a permissible range; in the first control section, each time, only a person is permitted to enter into the door of the first control section;
monitors arranged in the second and third control section for determining movement of persons in the control sections; the monitors having monitor recording systems which are connected to a programmable logic device electrically; signals being transferred to the programmable logic device for processing; the programmable logic device determining whether the entering persons are greater than two and determining whether it is necessary to trigger an alarm; and the programmable logic device serving to control the states in the second and third control sections.

2. The multiple safety monitoring system as claimed in claim 1, wherein the state for opening the door is that whether the card number is authorized in the card reader of the door, wherein the card number is stored in a memory of the card reader.

3. The multiple safety monitoring system as claimed in claim 1, wherein each door of each control section has an electronic lock which receives signals from the programmable logic device so as to be opened or closed.

4. The multiple safety monitoring system as claimed in claim 1, wherein the card reader reads card data in the card reader and then transfers the data to a power module; the power module drives a relay according to the kind of the signal and the signal is transferred to the programmable logic device.

5. The multiple safety monitoring system as claimed in claim 1, wherein the protocol converter serves to convert data to another protocol for communication.

6. The multiple safety monitoring system as claimed in claim 1, wherein the central control system receives data for processing and analyzing and then transfers these data to the programmable logic device and reads address in the programmable logic device for analyzing and application.

7. The multiple safety monitoring system as claimed in claim 1, wherein the monitor recording system has a lens, a main frame, a monitor for detection the dynamic change of the control section, if abnormal occurs, the signals will transfer to respective addresses in the programmable logic device.

8. The multiple safety monitoring system as claimed in claim 1, wherein the central control system polls the carders for downloading data; the central control system analyzes data from the card and determines a source of the data; the data from the central control system is transferred to the programmable logic device for logic control by the programmable logic device.

9. The multiple safety monitoring system as claimed in claim 9, wherein entering data of each position entering into the control section is recorded.

10. The multiple safety monitoring system as claimed in claim 1, wherein the entering data is stored in the card reader; the data is operated, analyzed by system software so as to know the number of persons passed through.

11. The multiple safety monitoring system as claimed in claim 1, wherein images for entering persons are captured in the second and third control sections; and the movements of the persons are transferred to the programmable logic device.

12. The multiple safety monitoring system as claimed in claim 1, wherein the programmable logic device determines to trigger an alarm according to the number of entering person at the last card reader and he movement of the person in the control section detected by the monitor recording system and the recorded card number and weight.

13. The multiple safety monitoring system as claimed in claim 1, wherein conditions for determining number of entering persons are recorded in the programmable logic device and the central control system determines the weight.

14. The multiple safety monitoring system as claimed in claim 1, wherein the programmable logic device determines whether the number of entering persons is greater than or equal to 2 and if the returning signal from the monitor recording system is one, it represents that the person moves.

15. The multiple safety monitoring system as claimed in claim 1, wherein if the number of entering persons is greater than or equal to 2 and if no other person enters into the control section within a predetermined time, an alarm is triggered.
